(19) United States
(12) Patent Application Publication
(10) Pub. No.: US 2020/0134580 A1
(43) Pub. Date: Apr. 30, 2020

(54) CLICK SERVICE

(71) Applicant: AHMAD ABO ALSHEGRI, Montreal (CA)

(72) Inventor: Ahmad Abo Alsheghi, Montreal (CA)

(21) Appl. No.: 16/581,805

(22) Filed: Sep. 25, 2019

(30) Foreign Application Priority Data
Sep. 26, 2018 (CA) 3018719

(51) Int. Cl. G06Q 20/08; G06Q 50/18

(52) U.S. Cl. CPC G06Q 20/0855; G06Q 50/188

(57) ABSTRACT

Click service services is to connect people and businesses with different types of services providers In unique, easy and beneficial way by using the most advanced technology devices and technics, it will use mobile application, platform and website.

Since I am accountant and have experience with different types of businesses I realized that There is a need for easy cheap services with benefit for customers, the customers will choose click service because they will make money out of it instead of getting supplier from classified Adds without getting any commission and it is easier to get supplier.

Our unique service will allow the customers to get cash back from services they don't get cash back usually from also it will save them time to find the suppliers and will provide the suppliers with more customers

Click service will create platform and mobile application and website to connect people and businesses with different kinds of services providers who signed contracts with click service like electricians, nurses, plumbers, care givers, restaurants, supermarkets, coffee shops, cloths stores, lawyers, accountants, financial services general workers website designers and platforms programmers, IT professionals and software programmers, computer and language and all teaching material teachers, cleaning services, taxi services, car dealers, insurance companies, real estate agents services, construction subcontractors, moving services, and all kinds of services needed in houses and businesses.

When customer click for service it will show on all service providers mobiles application to accept the order if he is available and the customer will get list of the ones who accepted the order to choose from and if he did not agree with the first one he will choose another one from the list.

when supplier finalize his service he must scan the customer mobile application bar code or our points card on his mobile application scanner provided by us then the customer will be charged by us and we will pay the service provider his share after deducting our 10% commission and we will keep the portion of the discount 5% for the customer as points he can redeem it by buying different goods from our store available on line or any time when he ask for another service from click service or cash back reward.

Or the supplier will charge the customer and we deduct only our commission 10% from the supplier account with us and give the customer 5% back to his account with us and all this will be done automatically through our platform

The customers and the suppliers will be asked when setting up the application on their mobiles to provide their credit cards information.

The customer will click on one option on the application to confirm that he received the service and paid for it to claim his cash back.

All the chat between the clients and the service provider will be visible to us.

The supplier will charge the prices that he agreed on with us either per hour or per service and doesn't have right to raise it or reduce it without our consent.

We will offer free chat service between customers and other free useful services.

We will have rating system for the service providers to encourage them to improve their service quality. We will add chat and social media tool on the application so we will benefit from charging on advertising on our application.

We will add sales websites on the application and take commission from them

We will add fee features on the applications that will eliminate the need to use another applications which will reduce the number of applications the consumer has on his mobile and will encourage him more to use ours.

### EXAMPLE: FOR RESTAURANTS

We will install our application on the restaurant case machine or we provide them with our device if the client eat in the restaurant he will scan the bar code on his application on the restaurant machine scanner to pay and in case of delivery he will scan it on the restaurant portable Device, we will get 15% commission from the restaurant and give the customer 5% discount as cash back on his account.

The embodiments of the invention in which an exclusive property or privilege is claimed are defined as follows:

1. Click service will create platform and mobile application and website to connect people and businesses with different kinds of our services providers who signed contracts with click service, like electricians, nurses, plumbers, care givers, restaurants, supermarkets, coffee shops, cloths stores, lawyers, accountants, financial services, general workers, website designers and platforms programmers, IT professionals and software programmers, computer and language teachers, cleaning services, taxi services, car dealers, insurance companies, real estate agents services, construction subcontractors, moving services, and all types of services needed in houses and businesses.
When customer ask for service it will show on all service providers mobiles application and the customer will get a list of the ones who accepted the order to choose from and if he did not agree with the first one he will choose another ones from the list.
when supplier finalize his service he must scan the customer mobile application bar code on his mobile application scanner provided by us then the customer will be charged by us and we will pay the service provider his share after deducting our 10% commission and we will keep the portion of the discount 5% for the customer as points he can redeem it by buying different goods from our store available on line or any time when he ask for another service from click service or cash back reward.
Or the supplier will charge the customer and we deduct only our commission 10% from the supplier account with us and give the customer 5% back to his account with us and all this will be done automatically through our platform.
The customer in order to get his points he must confirm receiving the service by pressing the option confirmed on our application.
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

2. To create platform and mobile application and website to connect people with restaurant service providers.
We will offer the customers electronic point card or he can use the bar code on our mobile application for discount which will be 5% of our 15% commission.
We will install our application on the restaurant case machine or we provide them with our device if the client eat in the restaurant he will scan the bar code on his application on the restaurant payment machine to pay and in case of delivery he will scan it on the restaurant portable device, we will get 15% commission from the restaurant and give the customer 5% discount as points on his account, the payments will come directly to us to take our 15% plus tax and deposit 85% plus tax in the restaurant account with us, Or the supplier will charge the customer and we deduct only our commission 15% from the supplier account with us and give the customer 5% back to his account with us and all this will be done automatically through our platform.
In case of food delivery service when customer clicks on the icon restaurant he will have a list of our restaurants to choose from their menu.
Other companies offering similar services are charging the restaurants 30% and more commission
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

3. Click service will create platform and mobile application and website to connect people and businesses with different kinds of services providers who signed contracts with click service like electricians, nurses, plumbers, care givers, restaurants, lawyers, accountants, financial services general workers website designers and platforms programmers, IT professionals and software programmers, computer and language and all teaching material teachers, cleaning services, taxi services, real estate agents services, construction subcontractors, moving services, and all kinds of services needed in houses and businesses.
When customer click for service it will show on all service providers mobiles application to accept the order if he is available and the customer will get list of the ones who accepted the order to choose from and if he did not agree with the first one he will choose another one from the list.
when supplier finalize his service he must scan the customer mobile application barcode or our points card on his mobile application scanner provided by us then the customer will be charged by us and we will pay the service provider his share after deducting our 10% commission and we will keep the portion of the discount 5% for the customer as points he can redeem it by buying different goods from our store available on line or any time when he ask for another service from click service or cash back reward.
Or the supplier will charge the customer and we deduct only our commission 10% from the supplier account with us and give the customer 5% back to his account with us and all this will be done automatically through our platform
The customers and the suppliers will be asked when setting up the application on their mobiles to provide their credit cards information.
All the chat between the clients and the service provider will be visible to us.
the supplier will charge the prices that he agreed on with us either per hour or per service and doesn't have right to raise it or reduce it without our consent. Some of the services poviders will be
Allowed to negotiate the price with the customers
We will offer free chat service between customers and other free useful services.
We will have rating system for the service providers to encourage them to improve their service quality. We will add chat and social media tool on the application so we will benefit from charging on advertising on our application.
We will add sales websites on the application and take commission from them
We will add fee features on the applications that will eliminate the need to use other applications which will reduce the number of applications the consumer has on his mobile and will encourage him more to use ours.
Our unique service will allow the customers to get cash back from services they don't get cash back usually for and the cash back will be higher than other competitors also it will save them time to find the suppliers and will provide the suppliers with more customers

4. To create platform and mobile application and website to connect people and businesses with Accounting and financial service providers.
When customer ask for service it will show on all service providers mobiles application and the customer will get list of the ones who accepted the order to choose from and if he did not agree with the first one he will choose another one from the list
We will offer the customers electronic point card or bar code on our mobile application for discount which will be 5% of our 10% commission and the supplier will charge the prices that he agreed on with us either per hour or per service to insure that we offer competitive prices.
when the supplier finalize his service he must scan the customer electronic point card or the mobile bar code on his mobile application provided by us then the customer will be charged by us and we will pay the service provider his share after deducting our 10% commission and we will
keep the portion of the discount 5% for the customer as points he can redeem it by buying different goods from our store available on line or any time when he ask for another service from click service or cash back
The customer in order to get his points he must confirm receiving the service by pressing the option confirmed on our application.
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

5. To create platform and mobile application and website to connect people and businesses with real estate agents.
When customer ask for service it will show on all service providers mobiles application and the customer will get a list of the ones who accepted the order to choose from and if he did not agree with the first one he can choose another one from the list
We will offer the customers electronic point card for discount which will be 10% of our 30% commission of the agent commission.
when the real estate agent finalize his service and get his commission and Since the real estate agent will get his commission from the home owner, he must inform us to deduct our 30% commission from his credit card and we will keep the portion of the discount 10% for the customer as points he can redeem it by buying different goods from our store available on line or any time when he ask for another service from click service or cash back.
The customer in order to get his points he must confirm receiving the service by pressing the option confirmed on our application.
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

6. To create platform and mobile application and website to connect people and businesses with plumber service providers.
When customer ask for service it will show on all service providers mobiles application and the customer will get list of the ones who accepted the order to choose from and if he did not agree with the first one he will choose another one from the list.
We will offer the customers electronic point card or mobile application bar code for discount which will be 5% of our 10% commission and the supplier will charge the prices that he agreed on with us either per hour or per service to insure that we offer competitive prices.
when the supplier finalize his service he must scan the customer electronic point card or mobile application bar code on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service or cash back.
Or the supplier will charge the customer and we deduct only our commission 10% from the supplier account with us and give the customer 5% back to his account with us and all this will be done automatically through our platform
And if the customer is a construction company that will sign contract with the plumber then The plumber must inform us when he sign the contract to deduct our 10% commission from his credit card, we will keep the portion of the discount 5% for the customer as points he can redeem it by buying different goods from our store available on line or any time when he ask for another service from click service or cash back.
The customer in order to get his points he must confirm receiving the service by pressing the option confirmed on our application.
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

7. To create platform and mobile application and website to connect people and businesses with IT professionals and software programmers.
When customer ask for service it will show on all service providers mobiles application and the customer will get list of the ones who accepted the order to choose from and if he did not agree with the first one he will choose another ones from the list.
We will offer the customers electronic point card or application barcode for discount which will be 5% of our 10% commission and the supplier will charge the prices that he agreed on with us either per hour or per service to insure that we offer competitive prices.
when the supplier finalize his service he must scan the customer electronic point card on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service.
Or the supplier will charge the customer and we deduct only our commission 10% from the supplier account with us and give the customer 5% back to his account with us and all this will be done automatically through our platform
And if the customer is a company or person want to sign contract with the IT professional and software programmer then service provider must inform us when he sign the contract to deduct our 10% commission from his credit card and we will keep the portion of the discount 5% for the customer as points he can redeem it by buying different goods from our store available on line or any time when he ask for another service from click service.
The customer in order to get his points he must confirm receiving the service by pressing the option confirmed on our application.
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

8. To create platform and mobile application and website to connect people and businesses with cleaning services providers
When customer ask for service it will show on all service providers mobiles application and the customer will get list of the ones who accepted the order to choose from and if he did not agree with the first one he will choose another one from the list
We will offer the customers electronic point card and mobile barcode for discount which will be 5% of our 10% commission and the supplier will charge the prices that he agreed on with us either per hour or per service to insure that we offer competitive prices.
when the supplier finalize his service he must scan the customer electronic point card or our application bar code on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service
Or the supplier will charge the customer and we deduct only our commission 10% from the supplier account with us and give the customer 5% back to his account with us and all this will be done automatically through our platform
And if the customer is a company or person want to sign contract with the cleaning services provider then the service provider must inform us when he sign the contract to deduct our 10% commission from his credit card and we will keep the portion of the discount 5% for the customer as points he can redeem it by buying different goods from our store available on line or any time when he ask for another service from click service
The customer in order to get his points he must confirm receiving the service by pressing the option confirmed on our application.
Our unique service will allow the customers to get cash back from services they don't get cash back usually from and the cash back will be higher than other competitors also it will save them time to find the suppliers and will provide the suppliers with more customers
Click service will impose in the contract with the suppliers penalty of $10,000 in case of fraud like dealing with our customers without paying us our commission.

9. To create platform and mobile application and website to connect people and construction companies with Construction subcontractors
When customer ask for service it will show on all service providers mobiles application and the customer will get list of the ones who accepted the order to choose from and if he did not agree with the first one he will choose another ones from the list
We will offer the customers electronic point card or mobile bar code for discount which will be 5% of our 10% commission and the supplier will charge the prices that he agreed on with us either per hour or per service to insure that we offer competitive prices.
When the construction company or person want to sign contract with the Construction subcontractors then the service provider must inform us when he sign the contract to deduct our 10% commission from his credit card and we will keep the portion of the discount 5% for the customer as points he can redeem it by buying different goods from our store available on line or any time when he ask for another service from click service
The customer in order to get his points he must confirm receiving the service by pressing the option confirmed on our application.
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

10. To create platform and mobile application and website to connect people and businesses with the lawyers
When customer ask for service it will show on all service providers mobiles application and the customer will get list of the ones who accepted the order to choose from and if he did not agree with the first one he will choose another ones from the list
We will offer the customers electronic point card or mobile points barcode for discount which will be 5% of our 10% commission and the supplier will charge the prices that he agreed on with us either per hour or per service to insure that we offer competitive prices.
when the supplier finalize his service he must scan the customer electronic point card or our application barcode on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service or cash back
Or the supplier will charge the customer and we deduct only our commission 10% from the supplier account with us and give the customer 5% back to his account with us and all this will be done automatically through our platform
The customer in order to get his points he must confirm receiving the service by pressing the option confirmed on our application.
Click service will impose in the contract with the suppliers penalty of $10,000 in case of fraud like dealing with our customers without paying us our commission.
Our unique service will allow the customers to get cash back from services they don't get cash back usually from and the cash back will be higher than other competitors also it will save them time to find the suppliers and will provide the suppliers with more customers

11. To create platform and mobile application and website to connect people and businesses with Computer, language and all teaching material teachers.
When customer ask for service it will show on all service providers mobiles application and the customer will get list of the ones who accepted the order to choose from and if he did not agree with the first one he will choose another one from the list
We will offer the customers electronic point card or mobile points barcode for discount which will be 5% of our 10% commission and the teacher will charge the prices that he agreed on with us either per hour or per service to insure that we offer competitive prices.
when the supplier finalize his service he must scan the customer electronic point card or barcode on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service
Or the supplier will charge the customer and we deduct only our commission 10% from the supplier account with us and give the customer 5% back to his account with us and all this will be done automatically through our platform
The customer in order to get his points he must confirm receiving the service by pressing the option confirmed on our application.
Our unique service will allow the customers to get cash back from services they don't get cash back usually from and the cash back will be higher than other competitors also it will save them time to find the suppliers and will provide the suppliers with more customers
Click service will impose in the contract with the suppliers penalty of $10,000 in case of fraud like dealing with our customers without paying us our commission.

12. To create platform and mobile application and website to connect people and businesses with website designers and platform programmers
When customer ask for service it will show on all service providers mobiles application and the customer will get list of the ones who accepted the order to choose from and if he did not agree with the first one he will choose another one from the list
We will offer the customers electronic point card or mobile application barcode for discount which will be 5% of our 10% commission and the supplier will charge the prices that he agreed on with us either per hour or per service to insure that we offer competitive prices.
when the supplier finalize his service he must scan the customer electronic point card or mobile barcode on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service or cash back.
Or the supplier will charge the customer and we deduct only our commission 10% from the supplier account with us and give the customer 5% back to his account with us and all this will be done automatically through our platform
The customer in order to get his points he must confirm receiving the service by pressing the option confirmed on our application.
Our unique service will allow the customers to get cash back from services they don't get cash back usually from and the cash back will be higher than other competitors also it will save them time to find the suppliers and will provide the suppliers with more customers
Click service will impose in the contract with the suppliers penalty of $10,000 in case of fraud like dealing with our customers without paying us our commission.

13. To create platform and mobile application and website to connect people and businesses with Nurses and care givers
When customer ask for service it will show on all service providers mobiles application and the customer will get list of the ones who accepted the order to choose from and if he did not agree with the first one he will choose another one from the list
We will offer the customers electronic point card or mobile barcode for discount which will be 5% of our 10% commission and the supplier will charge the prices that he agreed on with us either per hour or per service to insure that we offer competitive prices.
when the supplier finalize his service he must scan the customer electronic point card or the mobile barcode on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service
Or the supplier will charge the customer and we deduct only our commission 10% from the supplier account with us and give the customer 5% back to his account with us and all this will be done automatically through our platform
The customer in order to get his points he must confirm receiving the service by pressing the option confirmed on our application.
Our unique service will allow the customers to get cash back from services they don't get cash back usually from and the cash back will be higher than other competitors also it will save them time to find the suppliers and will provide the suppliers with more customers
Click service will impose in the contract with the suppliers penalty of $10,000 in case of fraud like dealing with our customers without paying us our commission.

14. To create platform and mobile application and website to connect people and businesses with taxi services
When customer ask for service it will show on all service providers mobiles application and the customer will get list of the ones who accepted the order to choose from and if he did not agree with the first one he will choose another one from the list
We will offer the customers electronic point card or mobile points barcode for discount which will be 5% of our 10% commission and the supplier will charge the prices that he agreed on with us either per hour or per service to insure that we offer competitive prices.
when the supplier finalize his service he must scan the customer electronic point card or the mobile barcode on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service
Or the supplier will charge the customer and we deduct only our commission 10% from the supplier account with us and give the customer 5% back to his account with us and all this will be done automatically through our platform
The customer in order to get his points he must confirm receiving the service by pressing the option confirmed on our application.
Our unique service will allow the customers to get cash back from services they don't get cash back usually from and the cash back will be higher than other competitors also it will save them time to find the suppliers and will provide the suppliers with more customers
Click service will impose in the contract with the suppliers penalty of $10,000 in case of fraud like dealing with our customers without paying us our commission.

15. To create platform and mobile application and website to connect people and businesses with general workers and skilled workers
When customer ask for service it will show on all service providers mobiles application and the customer will get list of the ones who accepted the order to choose from and if he did not agree with the first one he will choose another one from the list
We will offer the customers electronic point card or mobile barcode for discount which will be 5% of our 10% commission and the supplier will charge the prices that he agreed on with us either per hour or per service to insure that we offer competitive prices.
when the supplier finalize his service he must scan the customer electronic point card or the mobile barcode on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service
Or the supplier will charge the customer and we deduct only our commission 10% from the supplier account with us and give the customer 5% back to his account with us and all this will be done automatically through our platform
If the customer (employer) wants to hire the worker permanently he must pay us commission equal to one month salary
The customer in order to get his points he must confirm receiving the service by pressing the option confirmed on our application.
Our unique service will allow the customers to get cash back from services they don't get cash back usually from and the cash back will be higher than other competitors also it will save them time to find the suppliers and will provide the suppliers with more customers
Click service will impose in the contract with the suppliers penalty of $10,000 in case of fraud like dealing with our customers without paying us our commission.

16. To create platform and mobile application and website to connect people and businesses with moving service providers
When customer ask for service it will show on all service providers mobiles application and the customer will get list of the ones who accepted the order to choose from and if he did not agree with the first one he will choose another one from the list
We will offer the customers electronic point card or mobile application barcode for discount which will be 5% of our 10% commission and the supplier will charge the prices that he agreed on with us either per hour or per service to insure that we offer competitive prices.
when the supplier finalize his service he must scan the customer electronic point card or the mobile barcode on his mobile application provided by us then the customer will be charged by us and we will pay the service provider his share after deducting our 10% commission and we will keep the portion of the discount 5% for the customer as points he can redeem it by buying Different goods from our store available on line or any time when he ask for another service from click service
Or the supplier will charge the customer and we deduct only our commission 10% from the supplier account with us and give the customer 5% back to his account with us and all this will be done automatically through our platform
The customer in order to get his points he must confirm receiving the service by pressing the option confirmed on our application.
Our unique service will allow the customers to get cash back from services they don't get cash back usually from and the cash back will be higher than other competitors also it will save them time to find the suppliers and will provide the suppliers with more customers
Click service will impose in the contract with the suppliers penalty of $10,000 in case of fraud like dealing with our customers without paying us our commission.

17. Click service will create platform and mobile application and website to connect people and businesses with different types of our services providers who signed contracts with click service, like electricians, nurses, plumbers, care givers, restaurants, lawyers, accountants, financial services, general workers, website designers and platforms programmers, IT professionals and software programmers, computer and language teachers, cleaning services, taxi services, real estate agents services, construction subcontractors, moving services, and all types of services needed in houses and businesses.
When customer ask for service it will show on all service providers mobiles application and the customer will get list of the ones who accepted the order to choose from and if he did not agree with the first one he will choose another ones from the list.
We will offer the customers electronic point card for discount which will be 5% of our 10% commission and the supplier will charge the prices that he agreed on with us either per hour or per service.
when the supplier finalize his service he must scan the customer electronic point card on his mobile application provided by us then the customer will be charged by us and we will pay the service provider his share after deducting our 10% commission and we will keep the portion of the discount 5% for the customer as points he can redeem it by buying different goods from our store available on line or any time when he ask for another service from click service.
The customer in order to get his points he must confirm receiving the service by pressing the option confirmed on our application.
Click service will impose in the contract with the suppliers penalty of $10,000 in case of fraud like dealing with our customers without paying us our commission.
